(19) United States
(12) Patent Application Publication
(10) Pub. No.: US 2002/0171687 A1
(43) Pub. Date: Nov. 21, 2002

(54) Human relation display system

(76) Inventors: Chien-Chung Li, Taipei City (TW); Gen-Kuo Li, Taipei City (TW); Chien-Fu Li, Taipei City (TW); Yi-Te Lin, Taipei City (TW); Chun-Ming Liao, Taipei City (TW); Chien-Cheng Chang, Taipei Hsien (TW); Ling-Yen Lu, Taipei Hsien (TW); Ting-Wei Lu, Taipei Hsien (TW); I-Ping Fang, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 09/683,650

(22) Filed: Jan. 29, 2002

(30) Foreign Application Priority Data
May 15, 2001 (TW) 090111653

(51) Int. Cl. G09G 5/00

(52) U.S. Cl. 345/853; 345/855; 705/7

(57) ABSTRACT

A computer has a monitor and a processor. An interface system has a plurality of target data sets, at least one relation data set, a display program, a selection program, and an application program. In the plurality of target data sets, each target data set has an ID (identification) of a target. In the relation data sets, each relation data set has two IDs of two corresponding targets and a relation attribute of the two targets. The display program is used to display the plurality of target data sets and the relation data sets on the monitor in a relation graph format. Each target data set is displayed as an icon in the relation graph, and each relation data set is displayed in a linking graph format between the two icons corresponding to the two targets of the relation data set. The selection program is provided for a user to select the icons displayed on the monitor. The application program can be activated by the user to provide functionality such as distribution of e-mails to the IDs of selected icons.

### BACKGROUND OF INVENTION

1. Field of the Invention

The present invention relates to a display system and application, and more particularly, to a human relation display system.

2. Description of the Prior Art

With the growing concept of a global village, people are becoming more interested in familial relationships. Today, people are learning that what appears to be a stranger is, in fact, a distant relative. With the world wide web and systematized arrangements with databases, members in a family can use the technology of today to return to former, closely knit relationships, communicating and interacting with each other to strengthen inter-personal bonds. Currently, people are using notice boards, address books and hereditary records to reconstruct family trees.

In the typical computer system, a relational graph of human relationships is seldom seen. Some e-mail software may offer presentation in this manner, such as Microsoft Outlook and Outlook Express, but this is really just a set of personal information and group information in an address book. The current software does not clearly indicate relationships between people as a parent, child, a commanding officer, classmate or friend, much less indicating relationships in terms of a difference in official position and so on. Most software used to create family trees is limited to recording and storing information, and graphically indicating family member relationships must be done manually. Such software does not offer functionality such as communicating with others, recording a significant family event, providing detailed address information, etc. Generally, in e-mail systems, group names are simply used for rough categorizations. Designing an information structure to show the personal relationships between people, and application systems that can be used in conjunction with such an information structure, are important aspects that need improvement.

### SUMMARY OF INVENTION

It is therefore an objective of the present invention to provide a human relation system to resolve the above-mentioned problems.

Briefly described, the present invention interface system is designed for a computer system having a monitor and a processor. The interface system has a plurality of target data sets, at least one relation data set, a display program, a selection program, and an application program. In the plurality of target data sets, each target data set has an ID (identification) of a target. In the relation data sets, each relation data set has two IDs of two corresponding targets and a relation attribute for each of the two targets. The display program is used to display the plurality of target data sets and the relation data sets on the monitor in a relation graph format. Each target data set is displayed as an icon in the relation graph, and each relation data set is displayed in a linking graph format between the two icons corresponding to the two targets of the relation data set. The selection program is provided for a user to select the icons displayed on the monitor. And the application program can be activated by the user to provide certain functions such as distribution of E-mails to the IDs of the icons selected by using the selection program.

The present invention uses a dendritical structure to show complicated human relations, and utilizes different kinds of icons and the linking graph formats to clearly display relationships between people. All types of relationship in a family, or a business relationship in an office, or even relationships between friends, are capable of being show by the interface system. If other demands are desired, the application program is used to flexibly augment the tree structure to provide functionality beyond simply displaying and searching.

These and other objectives of the present invention will no doubt become obvious to those of ordinary skill in the art after reading the following detailed description of the preferred embodiment that is illustrated in the multiple figures and drawings.

### BRIEF DESCRIPTION OF DRAWINGS

FIG. 1 is a tree graph of a human relation interface system according to the present invention.

FIG. 2 is a function block diagram associated with the human relation interface system of FIG. 1.

FIG. 3 is a shows a selection function of the human relation interface system of FIG. 1.

### DETAILED DESCRIPTION

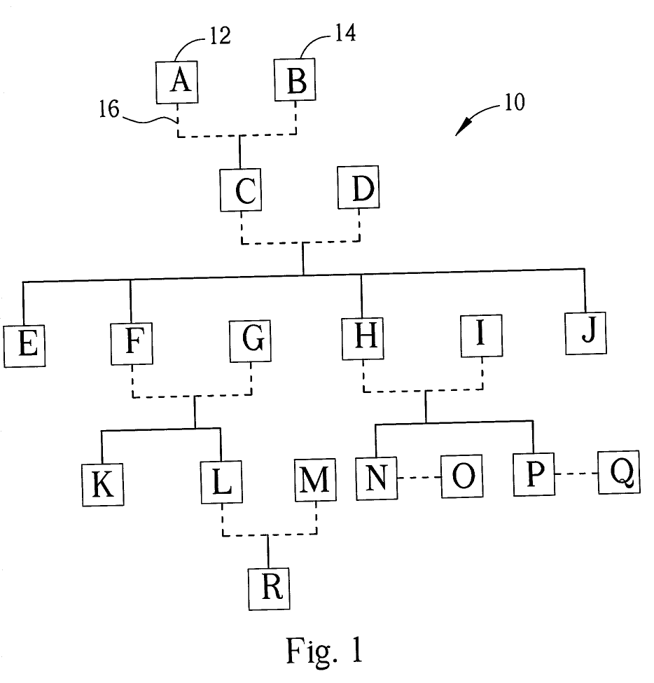

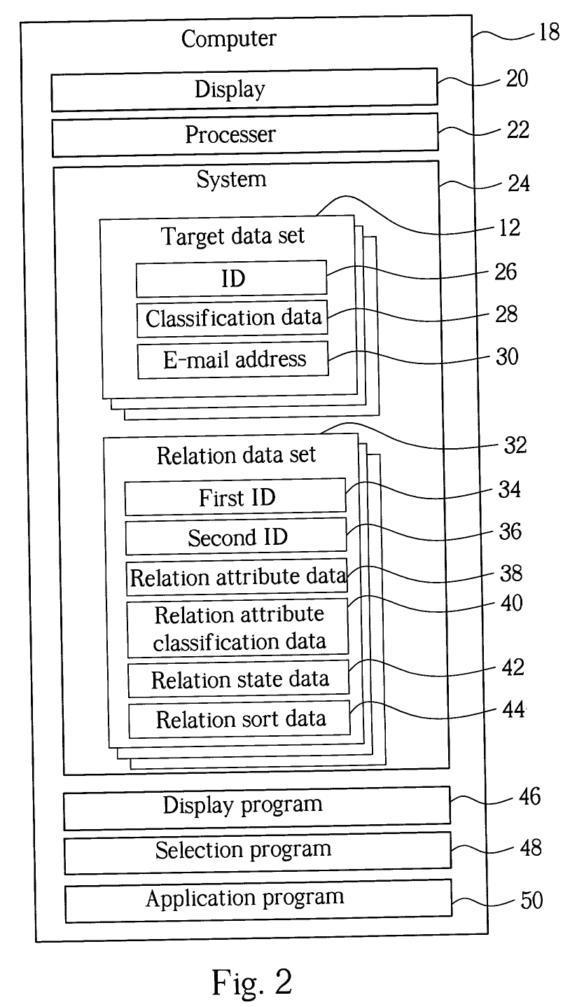

Please refer to FIG. 1 and FIG. 2. FIG. 1 is a tree graph according to a human relation interface system 24 of the present invention. FIG. 2 is a function block diagram of the human interface system 24 of the present invention. The present invention relates to an executable human relation interface system 24 for a computer 18. The computer 18 has a display 20 and a processor 22. The system 24 has a plurality of target data sets 12, at least one relation data set 32, a display program 46, a selection program 48, and an application program 50. Within the plurality of target data sets 12, each target data set 12 has an ID (identification) 26 of a target 12. As an example, a full name may be used as the ID 26. Each of the relation data sets 32 has an ID 34 and an ID 36 of two corresponding targets 12,and a relation attribute data 28 of the two targets 12, such as a conjugal relation.

As shown in FIG. 2, the display program 46 is used to display the plurality of target data sets 12 and the relation data sets 32 on the monitor 20 in the format of a relation graph 10. Each target data set 12 is displayed as an icon 14 in the relation graph 10, and each relation data set 12 is displayed in a linking graph format 16 between the two icons 14 corresponding to the two targets 12 of the relation data set 32. If the relation attribute data 38 of two relation data sets 32 are different, the display program 46 uses two different link graphs to represent the two different kinds of relation attributes.

As an example, it may be assumed that the relation graph 10 shown in FIG. 1 is a personal relationship graph 10. Each of the targets 12 from A to R are members in the personal relationship graph 10. In this case, A and B are married and have a child C. The conjugal relationship of A and B is thus shown in the linking graph 16 with a dotted line, whereas the relationship between A and C is shown in the linking graph 16 as a solid line. The relationship of A and C is thus parental in nature, as farther and daughter, mother and son, etc., and sex data in the target data sets 12 enables recognition of the sex of both A, B and C.

As shown in FIG. 2, the system 24 further comprises classification data 28, and an e-mail address 30. The classification data 28 is used to classify a target in the target data set 12, and indicates a group or an individual classification so that a target of the target data set 12 is indicated as a group or an individual.

The relation data set 32 of the system 24 further comprises relation attribute classification data 40, relation state data 42, and relation sort data 44. The relation attribute classification data 40 is used to determine classifications of the relation attribute data 38 of the relation data set 32.

The relation attribute classification data 40 indicates a personal relationship or a business relationship. The relation state data 42 is used to represent an existence state or an existence time of the relation attribute data 38 of the relation data set 32, such as dates of marriage or divorce.

The relation sort data 44 is used to represent sorting parameters of each target having a same relation attribute data 38 with a specific target 12. Please refer to FIG. 1 again. C and D get married and have children E, F, H and J. The relation sort data 44 of the relation data set 32 therefore sorts the four brothers and sisters from eldest to youngest. The sex data in the target data set 12 and the relation sort data 44 is used to determine that the siblings are brother, brother and younger sister, sister and younger brother, and sisters, respectively.

With reference back to FIG. 2, the human relation interface system 24 further comprises a selection program 48 and an application program 50. The selection program 48 enables a user to select the icons 14 displayed on the monitor 20 in a specific manner. Such selected icons 14 are marked as selected, so that the user may recognize the selected icons 14 from those that have not been selected. The user may utilize the selection program 48 to select a plurality of icons 14 so that the display program 46 can show on the monitor 20 the icons 14 chosen by the user and relations between each icon 14. Furthermore, the selection program 48 enables the user to select a specific icon, and the display program 46 shows on the monitor 20 the specific icon, each icon related to the specific icon, and corresponding relationships.

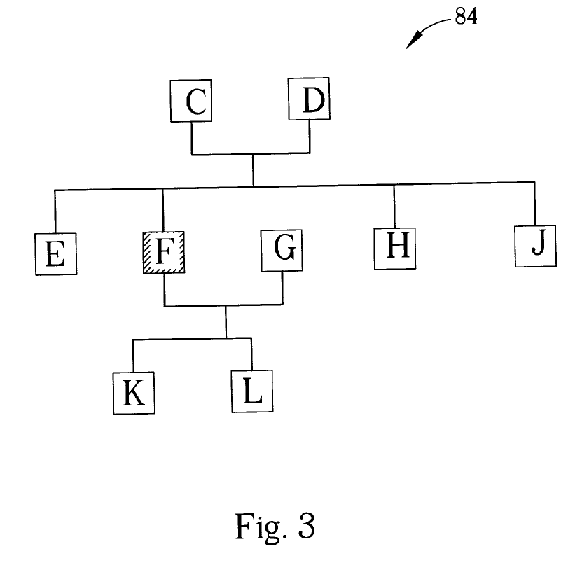

Please refer to FIG. 3,which is corresponding tree dendritical diagram of a selection function of the human interface system 24. In FIG. 3, the specific icon chosen by the user is F. A relation graph 84 is thus shown on the monitor 20 only having targets 12 corresponding to F. This includes Fs parents C and D, Fs brothers and sisters E, H and J, Fs spouse G, and Fs children K and L. As F is the icon chosen by the user, F is indicated as being selected with indicative marking.

With reference back to FIG. 2, the computer system 18 further comprises an application program 50. The application program 50 utilizes the icons 14 chosen by the selection program 48 of the ID data 26 to provide functionality to the user. The application program 50 may be an e-mail program 50 so that the user is capable of sending e-mail to the e-mail address 30 of each icon selected by the selection program 48. As shown in FIG. 3, if F desires to send e-mail to his nearest and dearest, after selecting the icon for F by way of the selection program 48, the display program 46 shows the relation graph 84, and then the e-mail program 50 is used to send email to all people chosen by the selection program 48.

In contrast with the prior method, the present invention uses a tree dendritical structure to clearly display the complicated network of human relationships, and utilizes different kinds of icons 14 and linking graph 16 formats to clearly indicate relationships between people. Whether personal relationships in a family, or business relationships in an office, or even relationships between friends, all are capable of display by the human relation interface system 24. If other demands are desired, the application program 50 interfaces with the system 24 to offer additional functionality to the dendritical structure 10 beyond simply displaying and searching.

Those skilled in the art will readily observe that numerous modification and alterations of the device may be made while retaining the teachings of the invention. Accordingly, the above disclosure should be construed as limited only by the metes and bounds of the appended claims.

What is claimed is:

1. An interface system for a computer, the computer comprising a monitor and a processor, the system comprising:
a plurality of target data sets, each target data set comprising an ID of a target;
at least a relation data set, each relation data set comprising IDs of two targets and a relation attribute data of the two targets;
a display program for displaying the plurality of target data sets and the relation data sets on the monitor in a relation graph format, each target data set displayed as an icon in the relation graph, and each relation data set displayed in a linking graph format between the two icons corresponding to the two targets of the relation data set;
a selection program for a user to select the icons displayed on the monitor; and
an application program activated by the user to provide a predetermined functionality to the IDs of the icons selected by using the selection program.

2. The interface system of claim 1 wherein if the relation attribute data of two relation data sets are different, the display program uses two different link graphs to represent the two different kinds of relation attributes.

3. The interface system of claim 1 wherein the relation data set further comprises a relation attribute classification data for determining classification of the relation attribute data of the relation data set.

4. The interface system of claim 3 wherein the relation attribute classification data is a personal relationship or a business relationship.

5. The interface system of claim 1 wherein the relation data set further comprises a relation state data for representing an existence state or an existence time of the relation attribute data of the relation data set.

6. The interface system of claim 1 wherein the relation data set further comprises a relation sort data for representing sorting parameters of each target having a same relation attribute data with a specific target.

7. The interface system of claim 1 wherein each target data set further comprises a classification data for representing a classification of a target in the target data set.

8. The interface system of claim 7 wherein the classification data is a group or an individual for representing a target of the target data set as a group or an individual.

9. The interface system of claim 1 wherein the selection program is used to show on the monitor, in a specific manner, icons chosen by the user so that the user is capable of recognizing the chosen icons.

10. The interface system of claim 1 wherein the selection program is used to show on the monitor a plurality of icons chosen by the user, and to show relations between each icon.

11. The interface system of claim 1 wherein the selection program is used to select a specific icon by the user, and the display program shows on the monitor the specific icon, each icon related to the specific icon, and corresponding relationships.

12. The interface system of claim 1 wherein each target data set further comprises an e-mail address of a target, and the application program is an email program so that the user is capable of sending e-mail to e-mail addresses of each icon chosen by the selection program.

13. A human relation display system for a computer, the computer comprising a monitor and a processor, the system comprising:
a plurality of target data sets, each target data set comprising an ID of a target;
at least a relation data set, each relation data set comprising IDs of two targets and relation attribute data of the two targets;
a display program for displaying the plurality of target data sets and the relation data sets on the monitor in a relation graph format, each target data set displayed as an icon in the relation graph, and each relation data set displayed in a linking graph format between the two icons corresponding to the two targets of the relation data set; and
a selection program for a user to select the icons displayed on the monitor, the display program showing icons chosen by the user on the monitor in a specific manner so that the user is capable of recognizing the chosen icons.

14. The human relation display system of claim 13 wherein if the relation attribute data of two relation data sets are different, the display program uses two different link graphs to indicate the two different kinds of relation attributes.

15. The human relation display system of claim 13 wherein the relation data set further comprises relation attribute classification data for indicating a classification of the relation attribute data of the relation data set.

16. The human relation display system of claim 15 wherein the relation attribute classification data indicates a personal relationship or a business relationship.

17. The human relation display system of claim 13 wherein the relation data set further comprises relation state data for representing an existence state or an existence time of the relation attribute data of the relation data set.

18. The human relation display system of claim 13 wherein the relation data set further comprises relation sort data for representing sorting parameters of each target having a same relation attribute data with a specific target.

19. The human relation display system of claim 13 wherein each target data set further comprises classification data for representing a classification of a target in the target data set.

20. The human relation display system of claim 19 wherein the classification data is a group or an individual for representing a target of the target data set as a group or an individual.

21. The human relation display system of claim 13 wherein the selection program is used to show on the monitor a plurality of icons chosen by the user, and to show relations between each icon.

22. The human relation display system of claim 13 wherein the selection program is used to select a specific icon by the user, and the display program shows on the monitor the specific icon, each icon related to the specific icon, and corresponding relationships.

23. A human relation display system for a computer, the computer comprising a monitor and a processor, the system comprising:
a plurality of target data sets, each target data set comprising an ID of a target;
at least a relation data set, each relation data set comprising IDs of two targets and relation attribute data of the two targets;
a display program for displaying the plurality of target data sets and the relation data sets on the monitor in a relation graph format, each target data set displayed as an icon in the relation graph, and each relation data set displayed in a linking graph format between the two icons corresponding to the two targets of the relation data set; and
a selection program for a user to select at least a target from the plurality of target data sets, the display program showing chosen targets and corresponding relationships and targets on the monitor in the relation graph format.

24. The human relation display system of claim 23 wherein if the relation attribute data of two relation data sets are different, the display program uses two different link graphs to represent the two different kinds of relation attributes.

25. The human relation display system of claim 23 wherein the relation data set further comprises relation attribute classification data for determining a classification of the relation attribute data of the relation data set.

26. The human relation display system of claim 25 wherein the relation attribute classification data is a personal relationship or a business relationship.

27. The human relation display system of claim 23 wherein the relation data set further comprises relation state data for representing an existence state or an existence time of the relation attribute data of the relation data set.

28. The human relation display system of claim 23 wherein the relation data set further comprises relation sort data for representing sort parameters of each target having a same relation attribute data with a specific target.

29. The human relation display system of claim 23 wherein each target data set further comprises classification data for representing a classification of a target in the target data set.

30. The human relation display system of claim 29 wherein the classification data is a group or an individual for representing a target of the target data set as a group or an individual.

31. The human relation display system of claim 23 wherein the selection program is used to show on the monitor a plurality of icons chosen by the user and relations between each icon.

32. The human relation display system of claim 23 wherein the selection program is used to select a specific icon by the user, and the display program shows on the monitor the specific icon, each icon related to the specific icon, and corresponding relationships.
